(19) United States
(12) Patent Application Publication
(10) Pub. No.: US 2025/0291056 A1
(43) Pub. Date: Sep. 18, 2025

(54) IMAGING SYSTEM WITH INCREASED EFFICIENCY

(71) Applicant: SiLC Technologies, Inc., Monrovia, CA (US)

(72) Inventors: Mehdi Asghari, La Canada Flintridge, CA (US); Amir Ali Tavallaee, San Francisco, CA (US); Nirmal Chindhu Warke, Saratoga, CA (US); Majid Boloorian, San Diego, CA (US)

(21) Appl. No.: 18/607,363

(22) Filed: Mar. 15, 2024

(51) Int. Cl. G01S 17/34; G01S 7/48; G01S 7/481; G01S 17/58

(52) U.S. Cl. CPC G01S 17/34; G01S 7/4802; G01S 7/4818; G01S 17/58

(57) ABSTRACT

The LIDAR system configured output system output signals. Each of the system output signals is output during a different output window. The LIDAR system is configured to receive system return signals that each includes light that is from one of the system output signals and that was reflected by an object located outside of the LIDAR system. The LIDAR system also includes light combiners. Each of the light combiners combines light from the system return signals with light from reference signals so as to generate composite light signals. Each of the composite light signals is beating at a beat frequency. The LIDAR system also includes an Analog-to-Digital Converter that receives data signals that area each beating at the beat frequency of one of the composite signals. The Analog-to-Digital Converter can receive each of the data signals within a different measurement window that is associated with the data signal. Each of the measurement windows overlaps several of the output windows.

### FIELD

The invention relates to optical devices. In particular, the invention relates to LIDAR systems.

### BACKGROUND

LIDAR systems scan a system output signal to multiple different sample regions in the LIDAR system's field of view. The LIDAR system uses light reflected by any objects with the sample regions to calculate LIDAR data for each of the sample regions. The LIDAR data for a sample region indicates the distance and/or radial velocity between the LIDAR system and the object.

One measure of LIDAR system efficiency is the amount of energy that the LIDAR system requires to generate the LIDAR data for each sample region. As the number of LIDAR system applications increases, the current energy requirements of LIDAR systems can limit the adoption of LIDAR systems into many applications. As a result, there is a need for a LIDAR system with increased efficiency levels.

### SUMMARY

A LIDAR system is configured to output system output signals. Each of the system output signals is output during a different output window. The LIDAR system is configured to receive system return signals. Each of the system return signals includes light that is from one of the system output signals and that was reflected by an object located outside of the LIDAR system. The LIDAR system also includes light combiners that each combine light from the system return signals with light from reference signals so as to generate composite light signals. Each of the composite light signals is beating at a beat frequency. The LIDAR system also includes an Analog-to-Digital Converter configured to receive data signals that are each beating at the beat frequency of one of the composite signals. The Analog-to-Digital Converter receives each of the data signals within a different measurement window. Each of the measurement windows overlaps several of the output windows.

A LIDAR system is configured to generate outgoing LIDAR signals. The LIDAR system has waveguides that receives the outgoing LIDAR signals such that different outgoing LIDAR signals are guided by different waveguides. Each of the outgoing LIDAR signals has a frequency versus time pattern that periodically repeats in cycles. Each cycle includes multiple chirp periods. The chirp rate of each outgoing LIDAR signal is constant in each of the chirp periods of the cycles of the outgoing LIDAR signal. Each of the outgoing LIDAR signals has different chirp rates and/or different chirp directions in the different chirp periods of the cycles of the outgoing LIDAR signal. The LIDAR system is also configured to output multiple system output signals. Each of the system output signals includes light from one of the outgoing LIDAR signals and different system output signals include light from different outgoing LIDAR signals. The duration for the output of each system output signal is less than or equal to one half of a duration of one or more of the chirp periods in the cycles of the outgoing LIDAR signal that is a source of the light included in the system output signal.

A LIDAR system outputs system output signals that each illuminates one of multiple sample regions in a field of view for the LIDAR system. The system output signals include first system output signals that illuminate a first one of the sample regions and second system output signals that illuminate a second one of the sample regions. The LIDAR system receives system return signals. Each of the system return signals includes light from one of the system output signals that was reflected by an object located outside of the LIDAR system. The LIDAR system includes light combiners that each combines light from the system return signals with light from reference signals so as to generate composite light signals that are each beating at a beat frequency. The LIDAR system includes an Analog-to-Digital Converter configured to receive data signals that area each beating at the beat frequency of a different one of the composite signals. The Analog-to-Digital Converter receives a second one of the data signals between a first one of the data signals and a third one of the data signals. The first data signal is beating at the beat frequency of one of the composite signals that includes light from one of the first system output signals. The second data signal is beating at the beat frequency of one of the composite signals that includes light from one of the second system output signals. The third data signal is beating at the beat frequency of one of the composite signals that includes light from one of the first system output signals. The LIDAR system also includes a processor configured to calculate a LIDAR data result for each of the sample regions from the beat frequencies. The LIDAR data result for each sample region indicates a radial velocity and/or a distance between the LIDAR system and an object positioned in the sample region.

### BRIEF DESCRIPTION OF THE FIGURES

FIG. 1A is a topview of a schematic of a bi-static LIDAR system.

FIG. 1B is a topview of a schematic of a monostatic LIDAR system.

FIG. 2 is a schematic of an example of a light source.

FIG. 3A through FIG. 3B illustrates an example of a light signal processor that is suitable for use as the light signal processor in a LIDAR system constructed according to FIG. 1A or FIG. 1B. FIG. 3A is a schematic of an example of a suitable composite signal generator.

FIG. 3B is a schematic of an example of a data processor configured to generate LIDAR data from the output of the composite signal generator shown in FIG. 3A.

FIG. 3C illustrates an example of the frequency versus time pattern for outgoing LIDAR signals.

FIG. 3D illustrates frequency versus time pattern of LIDAR output signals that can result from outgoing LIDAR signals having the frequency versus time patterns of FIG. 3C.

FIG. 3E shows measurement windows added to a portion of the frequency versus time patterns shown in FIG. 3D.

FIG. 4 is a cross section of a waveguide suitable for use as all or a portion of the waveguides on a LIDAR chip.

FIG. 5A is schematic of an example of a suitable signal selector.

FIG. 5B is schematic of an example of a suitable signal selector.

FIG. 6A is a topview of a portion of a LIDAR chip that includes an interface for optically coupling the LIDAR chip with a signal selector.

FIG. 6B is a perspective view of a portion of the LIDAR chip shown in FIG. 6A.

FIG. 6C is a perspective view of an amplifier chip suitable for use with the portion of the LIDAR chip shown in FIG. 6A and FIG. 6B.

FIG. 6D and FIG. 6E illustrate a LIDAR system that includes the LIDAR chip of FIG. 6A and FIG. 6B interfaced with the signal selector of FIG. 6C. FIG. 5D is a topview of the LIDAR system.

FIG. 6E is a cross section of the system shown in FIG. 6D taken along a line extending between the brackets labeled E in FIG. 6D.

### DESCRIPTION

A LIDAR system transmits system output signals. Each of the system output signals is transmitted over an output window that is a window in time. The LIDAR system also receives system return signals. Each of the system return signals includes light from one of the system output signals that was reflected by an object located outside of the LIDAR system. The LIDAR system combines light from the system return signals with light from reference signals so as to generate composite light signals that are each beating at a beat frequency. Each of the composite signals is associated with the system output signal that is a source of light included in the composite signal.

The LIDAR system generates data signals from the composite signals. Each of the data signals is associated with the composite signal from which the data signal is generated. The LIDAR system includes a beat signal identifier that receives the data signals and calculates the beat frequencies of the composite signal from which the data signal is generated. The LIDAR system can use the calculated beat frequencies to calculate LIDAR data for sample regions illuminated by the system output signals. The LIDAR data for a sample region indicates the distance and/or radial velocity between the LIDAR system and an object located in the sample region.

The beat signal identifier includes an Analog-to-Digital Converter that receives the data signals. The Analog-to-Digital Converter receives each of the data signals during a measurement window associated with the data signal. The beat frequency that the beat signal identifier calculates from a data signal received during a measurement window represents the beat frequency of the composite signal that is the source of the data signal. Since each of the composite signals is associated with the system output signal that is a source of light in the composite signal, each of the calculated beat frequencies and the data signal from which the beat frequency is calculated is also associated with a system output signal. For instance, each data signal and the beat frequency calculated from the data signal can be associated with the system output signal that is a source of light in the composite signal that is beating at the calculated beat frequencies. Accordingly, each data signal and the beat frequency calculated from the data signal can be associated with the system output signal from which it is generated.

The measurement windows are shifted such that the measurement window during which a first data signal is received overlaps the output window for the system output signal associated with the first data signal but also overlaps one of the output windows that opens subsequent to closure of the output window for the system output signal associated with the first data signal. As a result, the LIDAR system can start transmitting the next system output signal before the LIDAR system is done receiving the data signal from the prior system output signal. In contrast, the measurement window of prior LIDAR systems close concurrently with, or before, the transmission of the next system output signal. This configuration can leave extended periods of time where an ADC is not receiving a data signal. The ability to overlap transmission of a system output signal with receipt of the data signal from the prior system output signal reduces idle time of the ADC and accordingly reduces the level of energy needed to generate the LIDAR data for each sample regions.

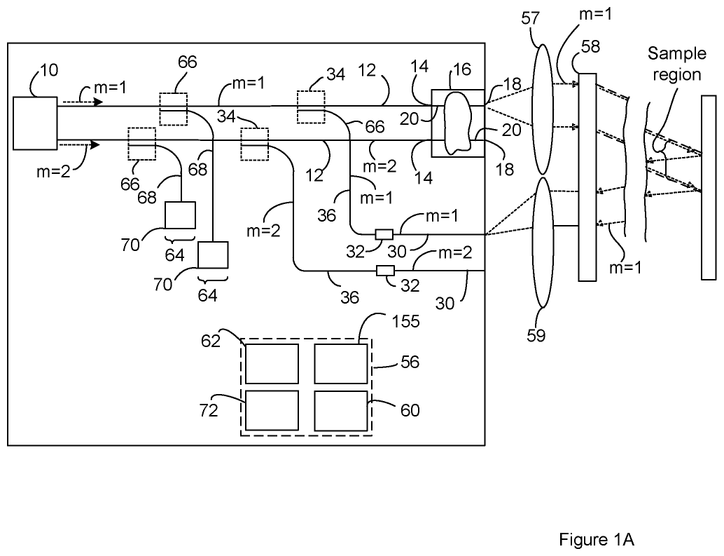

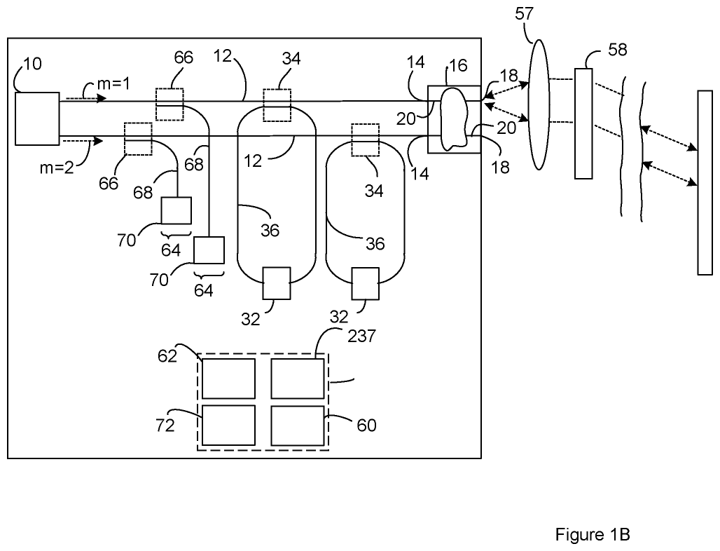

FIG. 1A is a topview of a schematic of a LIDAR system. The LIDAR system includes a LIDAR chip. In some instances, the LIAR chip is a semiconductor chip that includes a photonic circuit. The illustrated LIDAR chip includes a light source 10 that outputs multiple different outgoing LIDAR signals. Each of the different outgoing LIDAR signals is associated with an alternate channel index with a value from m=1 to m=M. For instance, FIG. 1A illustrates the light source 10 outputting an outgoing LIDAR signal labeled m=1 and an outgoing LIDAR signal labeled m=2. Light signals processed by the LIDAR system can be associated with the alternate channel index that is also associated with the outgoing LIDAR signal that is the source of the light signal. For instance, FIG. 1A includes a label that identifies a light signals output from the LIDAR system as associated the alternate channel index m=1 because the light signal includes light from the outgoing LIDAR signal labeled m=1. FIG. 1A also labels components that receive and/or process light signals associated with one of the alternate channel indices. For instance, FIG. 1A shows the optical pathways that light signals associated with alternate channel index m=1 travel through the LIDAR system and between the LIDAR system and an object located outside of the LIDAR system. The light signals associated with alternate channel index m=1 and the components that receive and/or process light signals associated with alternate channel index m=1 are labeled m=1. Additionally, light signals associated with alternate channel index m=2 and the components that receive and/or process light signals associated with alternate channel index m=2 are labeled m=2 in FIG. 1A. In order to simplify FIG. 1A, the optical pathways that light signals associated with alternate channel index m=2 travel between the LIDAR system and an object located outside of the LIDAR system are not shown.

In some instances, the multiple different outgoing LIDAR signals are concurrently output from the light source 10. For instance, during operation of some embodiments of the LIDAR system, the light source 10 concurrently outputs the outgoing LIDAR signal associated with alternate channel index m=2 and the outgoing LIDAR signal associated with alternate channel index m=1.

The LIDAR chip also includes utility waveguides 12 that each receives a different one of the outgoing LIDAR signals from the light source 10. Each of the utility waveguide 12 terminates at a port 14 through which light signals can exit and/or enter the utility waveguide 12. Each of the utility waveguides 12 carries the one of outgoing LIDAR signals to the port 14 at which the utility waveguides 12 terminates and the outgoing LIDAR signal exits the utility waveguides 12 through the port 14. An example of a port 14 is a facet of a utility waveguide 12.

The LIDAR chip includes a signal selector 16 that receives the outgoing LIDAR signals from the ports. The signal selector 16 is configured to select which of the outgoing LIDAR signals exits from the LIDAR chip and serves as a LIDAR output signal. For instance, the signal selector 16 can be operated so as to select whether the outgoing LIDAR signal associated with alternate channel m=1 exits from the LIDAR chip and serves as the LIDAR output signal or whether the outgoing LIDAR signal associated with alternate channel m=2 exits from the LIDAR chip and serves as the LIDAR output signal. The signal selector 16 can be configured such that the one or more unselected outgoing LIDAR signals either do not exit from the LIDAR chip or exit from the LIDAR chip as inactive LIDAR output signals. The optical output power of the inactive LIDAR output signal can be negligible relative to the optical output power of the selected LIDAR output signal. As a result, the LIDAR system does not calculate LIDAR data from light included in any inactive LIDAR output signals output from the LIDAR system.

The LIDAR chip includes multiple ports 18 through which light signals can exit and/or enter the LIDAR chip. For instance, the outgoing LIDAR signals can exit the LIDAR chip through the ports 18. Different ports can be associated with different alternate channel indices. For instance, the outgoing LIDAR signal associated with alternate channel index m can be received by the port 18 that is also associated with alternate channel index m. The ports 18 associated with different alternate channel indices can be spatially separated on the LIDAR chip.

The ports 18 can be included in the signal selector 16. Alternately, the ports 18 can be included in one or more optical components on the LIDAR chip. For instance, each of the ports 18 can be part of a waveguide included on the LIDAR chip. FIG. 1A illustrates the signal selector 16 having multiple selector waveguides 20 that each receives a different one of the outgoing LIDAR signals. Each of the selector waveguides 20 terminates at a facet that serves as a port 18. Each of the selector waveguides carries one of the outgoing LIDAR signals to a port 18 through which the outgoing LIDAR signals exit the LIDAR chip and serves as a LIDAR output signal. For instance, a facet that serves as a port 18 can be positioned at an edge of the chip so the outgoing LIDAR signal traveling through the port 18 exits the chip and serves as a LIDAR output signal. The signal selector 16 can include optical components 22 in addition to the selector waveguides 20.

Light from each of the LIDAR output signal travels away from the LIDAR system and may be reflected by objects in the path of the LIDAR output signal. When the LIDAR output signal is reflected, at least a portion of the reflected light travels returns to the LIDAR system in a system return signal. Additionally, at least a portion of the reflected light returns to the LIDAR chip as a LIDAR input signal that includes light from the system return signal. In some instances, the system return signal can serve as the LIDAR input signal.

The LIDAR chip can include multiple channel waveguides 30 that each receives a different one of the LIDAR input signals. The channel waveguides 30 have entry ports positioned such that different channel waveguides 30 receives LIDAR input signals associated with different alternate channel indices. As an example, the channel waveguide 30 associated with alternate channel index m=1 can receive the LIDAR input signal associated with alternate channel index m=1 and the channel waveguide 30 associated with alternate channel index m=2 can receive the LIDAR input signal associated with alternate channel index m=2.

The portion of the LIDAR input signal that enters a channel waveguide 30 can serve as a comparative signal that includes or consists of light from the LIDAR input signal. Each of the channel waveguides 30 is configured to carry the comparative signal received by that channel waveguide 30 to one of multiple different composite signal generators 32. Each of the composite signal generators 32 is associated with one of alternate channel indices. For instance, each of the composite signal generators 32 and the comparative signals received by the composite signal generator 32 are associated with the same alternate channel index. As an example, the comparative signal associated with alternate channel index m=1 is received at the composite signal generator 32 associated with alternate channel index m=1.

A splitter 34 is positioned along each of the utility waveguides. Each of the splitters 36 is configured to move a portion of the outgoing LIDAR signal carried on the utility waveguide from the utility waveguide 12 to a reference waveguide 36 as a reference signal. Each reference waveguide 36 carries one of the reference signals to one of the composite signal generators 32 for further processing. Each of the composite signal generators 32 and the reference signal received by the composite signal generator 32 are associated with the same alternate channel index. As an example, the reference signal associated with alternate channel index m=1 is received at the composite signal generator 32 associated with alternate channel index m=1. Accordingly, each composite signal generator 32, the reference signal received by the composite signal generator 32, and the comparative signal received by the composite signal generator 32 are each associated with the same alternate channel index. Each of the splitters 36 can also be configured such that a second portion of the outgoing LIDAR signal received by the splitter 34 is output from the splitter on the utility waveguide 12 and continues to serve as the outgoing LIDAR signal. Suitable splitters 34 include, but are not limited to, wavelength independent splitters such as optical couplers, directional couplers, Y-junctions, and multimode interference devices (MMIs).

The LIDAR system can optionally include components in addition to the LIDAR chip. For instance, the LIDAR system can include one or more signal shapers that shape the signals output from the LIDAR system and/or one or more beam scanners that can be used to steer a system output signals to different sample regions in the field of view. The sample regions can effectively be considered three dimensional pixels that can be stitched together to define the field of view. The LIDAR system of FIG. 1A includes a first signal shaper 57 that receives the LIDAR output signals and outputs a shaped output signal. A beam scanner 58 receives the shaped output signal and outputs the system output signal. The beam scanner 58 can steer the system output signals to the desired sample region in the field of view. When a system output signal is reflected by an object, the reflected light can serve as a system return signal. Each of the system return signals is associated with a different one of the alternate channel indices. The beam scanner 58 can receive the system return signal as shown in FIG. 1A or the beam scanner 58 can be constructed such that the system return signals bypasses the beam scanner 58. The LIDAR system also includes a second signal shaper 59 that receives the system return signals and outputs the LIDAR input signals that are received by the LIDAR chip.

In FIG. 1A, the first signal shaper 57 is a lens configured to collimate the shaped output signal and the second signal shaper 59 is a lens configured to focus the LIDAR input signal. In some instances, the second signal shaper 59 is configured to focus the LIDAR input signal at or near a facet 32 of one or more of the channel waveguides 30. The first signal shaper 57 and the second signal shaper 59 can be combined in a single component. For instance, a single lens can serve as the first signal shaper 57 and the second signal shaper 59.

When the first signal shaper 57 is a lens, each of the LIDAR output signals can have a different angle of incidence on the lens as shown in FIG. 1A and FIG. 1B. The change in the angle of incidence can cause the LIDAR output signals associated with different alternate channel indices to travel away from the first signal shaper 57 in different directions and can accordingly cause the system output signals to travel away from the LIDAR system in different directions. As a result, the system output signals associated with different alternate channel indices can be directed to different sample regions.

When the first signal shaper 57 and the second signal shaper 59 are each a lens, the lens serving as the second signal shaper 59 can have a wider aperture than the lens serving as the first signal shaper 57. The increased aperture of the lens serving as the second signal shaper 59 can improve light collection efficiency. A suitable ratio for the aperture of the lens serving as the second signal shaper 59: the aperture of the lens serving as the first signal shaper 57 includes apertures greater than 1:1, 2:1, or 3:1 and/or less than 5:1, 10:1, or 20:1.

In some instances, components such as signal shapers and beam scanners can be mounted on and/or integrated with the LIDAR chip. In instances, when the LIDAR system excludes components in addition to the LIDAR chip, the signal output from the LIDAR chip can serve as the system output signal. For instance, when a LIDAR system includes a LIDAR chip constructed according to FIG. 1A and excludes components in addition to the LIDAR chip, the LIDAR output signal can serve as the system output signal.

The LIDAR system can include electronics 56. When the LIDAR system includes a beam scanner 58, the LIDAR system can include a steering controller 60 that is configured to operate the beam scanner 58 so as to steer the system output signals to different sample regions within the field of view of the LIDAR system.

The electronics 56 can also include a light source controller 62. The light source controller 62 can operate the light source 10 such that each of the outgoing LIDAR signals, and accordingly, the resulting system output signals, has a particular frequency versus time pattern. For instance, the light source controller 62 can operate the light source such that each of the outgoing LIDAR signals, and accordingly the resulting system output signals, has different chirp rates during different data periods.

The LIDAR chip can optionally include one or more control branches 64 for controlling the operation of the light source 10. For instance, the one or more control branches 64 can provide a feedback loop that the light source controller 62 uses in operating the light source such that the outgoing LIDAR signals have the desired frequency versus time pattern. An example of a control branch 64 includes a directional coupler 66 that moves a portion of the outgoing LIDAR signal from one of the utility waveguides 12 onto a control waveguide 68. The coupled portion of the outgoing LIDAR signal serves as a tapped signal. Although FIG. 1A illustrates a directional coupler 66 moving a portion of the outgoing LIDAR signal onto the control waveguide 68, other signal-tapping components can be used to move a portion of the outgoing LIDAR signal from the utility waveguide 12 onto the control waveguide 68. Examples of suitable signal tapping components include, but are not limited to, y-junctions, and MMIs.

The control waveguide 58 carries the tapped signal to a feedback system 70. The feedback system 70 can include one or more light sensors (not shown) that convert light signals carried by the feedback system 70 to electrical signals that are output from the feedback system 70. The light source controller 62 can receive the electrical signals output from the feedback system 70. During operation, the light source controller 62 can adjust the frequency of the outgoing LIDAR signal in response to output from the electrical signals output from the feedback system 70. An example of a suitable construction and operation of feedback system 70 and light source controller 62 is provided in U.S. patent application Ser. No. 16/875,987, filed on 16 May 2020, entitled “Monitoring Signal Chirp in outbound LIDAR signals,” and incorporated herein in its entirety; and also in U.S. patent application Ser. No. 17/244,869, filed on 29 Apr. 2021, entitled “Reducing Size of LIDAR System Control Assemblies,” and incorporated herein in its entirety.

Although FIG. 1A illustrates a control branch 64 associated with each of the outgoing LIDAR signals, in some instances, the LIDAR system can be configured such that the light source controller 62 adjusts the frequency of multiple outgoing LIDAR signals in response to output from the electrical signals output from a single feedback system 70. The number of outgoing LIDAR signals having frequencies that the light source controller 62 adjusts in response to output from a single feedback system 70 can be a function of the construction of the light source 10.

The electronics 56 can also include a selector controller 72 configured to operate the signal selector 16 so as to select which of the outgoing LIDAR signals exit from the LIDAR chip.

FIG. 1A illustrates an example of a bi-static LIDAR system, however, the LIDAR system can be monostatic. FIG. 1B illustrates the LIDAR system of FIG. 1A modified to serve as a monostatic LIDAR system. The LIDAR system of FIG. 1B optionally includes a beam scanner 58 that receives the system return signals. The first signal shaper 57 receives the system return signals and outputs the LIDAR input signals that are received by the LIDAR chip.

The LIDAR input signals enter the LIDAR chip through the ports 18. The port 18 associated with alternate channel index m receives the LIDAR input signal associated with alternate channel index m. As an example, the port 18 associated with alternate channel index m=1 can receive the LIDAR input signal associated with alternate channel index m=1 and the port 18 associated with alternate channel index m=2 can receive the LIDAR input signal associated with alternate channel index m=2. The signal selector 16 receives the LIDAR input signals. The LIDAR input signals pass through the signal selector 16 and are received at the utility waveguides 12. The utility waveguide 12 associated with alternate channel index m receives the LIDAR input signal associated with alternate channel index m.

Each of the utility waveguides 12 carries one of the LIDAR input signals to one of the splitters 34. Each of the splitters 36 is configured to move a portion of the LIDAR inputs signal from the utility waveguide 12 to a comparative waveguide 30 as a comparative signal. Each comparative waveguide 30 carries one of the comparative signals to one of the composite signal generators 32 for further processing. The comparative waveguides 30 are configured such that the composite signal generator 32 and the comparative signal received by the composite signal generator 32 are associated with the same alternate channel index. As an example, the comparative signal associated with alternate channel index m=1 is received at the composite signal generator 32 associated with alternate channel index m=1. Accordingly, each composite signal generator 32, the reference signal received by the composite signal generator 32, and the comparative signal received by the composite signal generator 32 are each associated with the same alternate channel index.

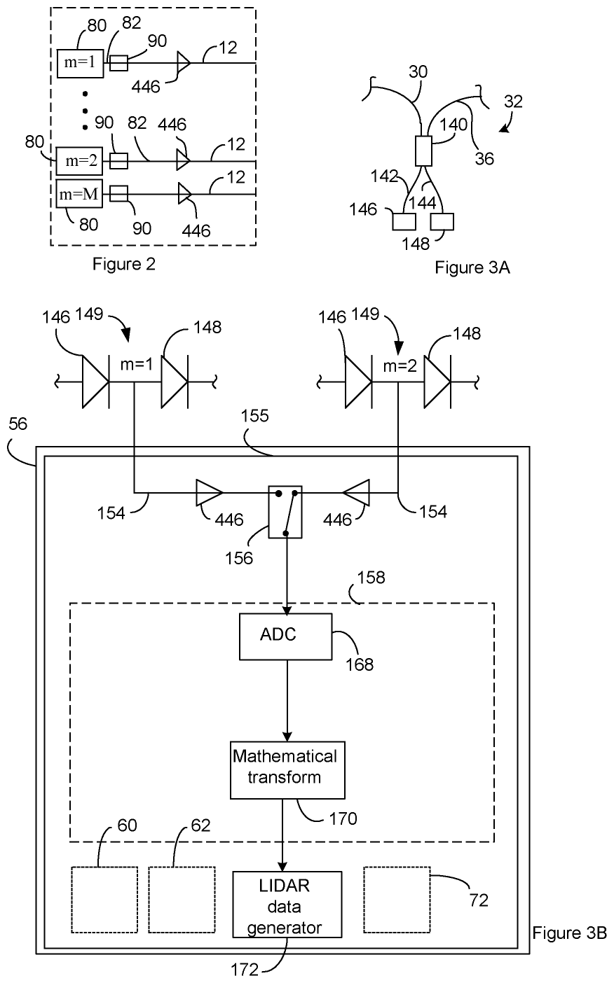

FIG. 2 illustrates an example of a light source 10 suitable for used in conjunction with the LIDAR system. The light source 10 includes multiple laser sources 80. Each of the laser sources 80 is configured to output an alternate channel signal on a source waveguide 82. Each laser source 80 can be associated with a different alternate channel index. For instance, the laser source 80 associated with alternate channel index m=1 is labeled m=1 and the laser source 80 associated with alternate channel index m=2 is labeled m=2. The laser source 80 associated with alternate channel index m outputs an alternate channel signal associated with alternate channel index m. A suitable laser source 80 includes, but is not limited to, semiconductor lasers such as External Cavity Lasers (ECLs), Distributed Feedback lasers (DFBs), Discrete Mode (DM) lasers and Distributed Bragg Reflector lasers (DBRs).

In some instances, each of the alternate channel signals output from a laser source 80 serves as one of the outgoing LIDAR signals. The light source controller 62 can tune the frequency of the alternate channel signal output from a laser source 80, and accordingly, the frequency of the resulting outgoing LIDAR signal, by tuning the electrical current through the laser source 80 and/or the bias level applied to the laser source 80. Since a different laser source 80 is the source of each outgoing LIDAR signal, the frequency patterns of the outgoing LIDAR signals and the resulting system output signals can be independently tuned.

The light source 10 can optionally include one or more modulators 90 that are each positioned so as to modulate one of the alternate channel signals. For instance, the light source 10 can optionally include one or more modulators 90 positioned along each of the source waveguides 82. When the light source 10 includes one or more modulators 90, the light source controller 62 can tune the frequency of the alternate channel signal output from a laser source 80, and accordingly, the frequency of the resulting outgoing LIDAR signal, by tuning the electrical current through the modulator 90 and/or the bias level applied to the modulator 90. Since different modulators 90 can be operated to modulate the frequency patterns of different alternate channel signals and the resulting outgoing LIDAR signals, the frequency patterns of the outgoing LIDAR signals and the resulting system output signals can be independently tuned. Suitable modulators 90 include, but are not limited to, thermal heaters, PIN carrier injection phase shifters, PN depletion based phase shifters, and Mach-Zehnder modulators. An example of a suitable optical attenuator can be found in U.S. patent application Ser. No. 17/396,616, filed on Aug. 6, 2021, entitled “Carrier Injector Having Increased Compatibility,” and incorporated herein in its entirety.

The different alternate channel signals can have the same or different wavelengths. Accordingly, the resulting outgoing LIDAR signals can have the same or different wavelengths. As a result, the light 10 can have other configurations. For instance, the light source 10 can have a single laser source 80 that outputs a precursor signal. The light source 10 can include one or more splitters that split the precursor signal into the alternate channel signals. The light source 10 can include modulators that allow the frequency of the different alternate channel signals to be modulated.

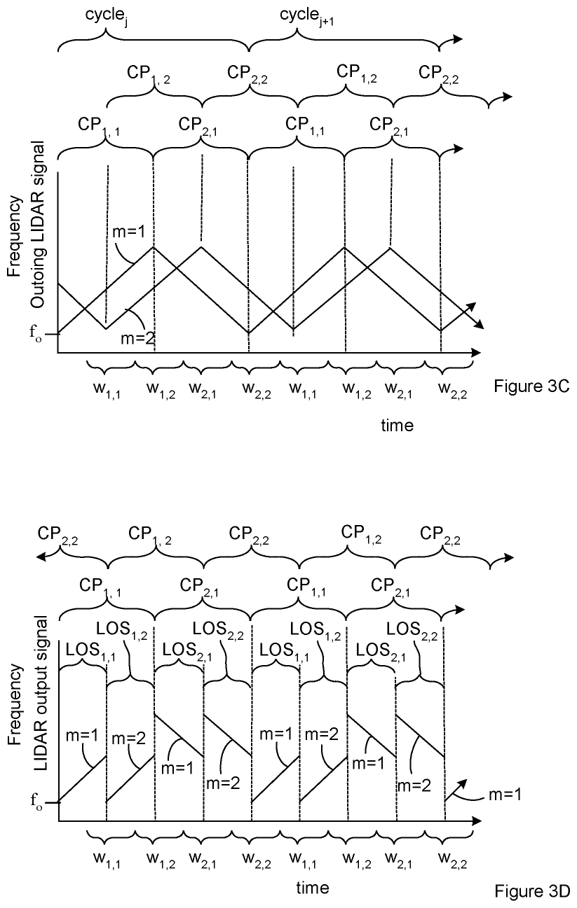

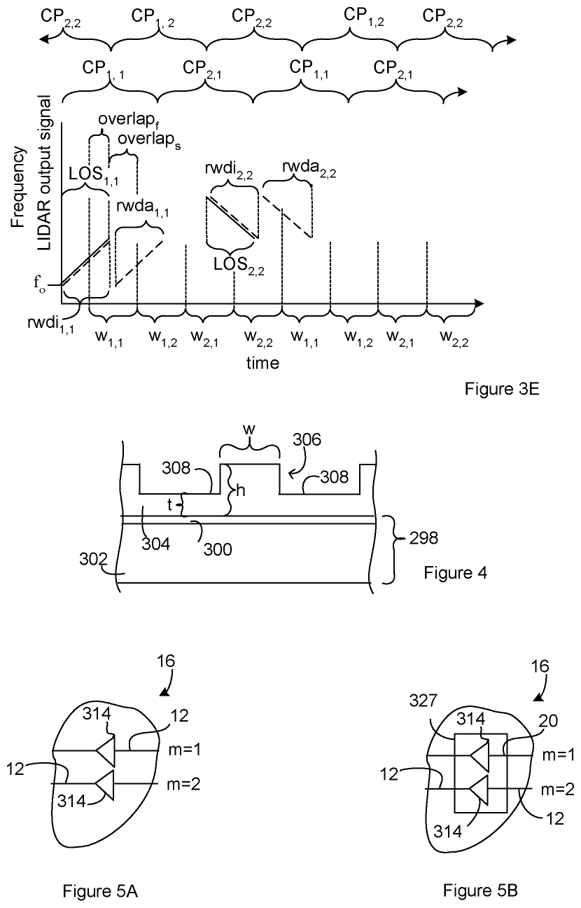

FIG. 3A illustrates an example of a composite signal generator 32 that is suitable for use as any, all, or each of the composite signal generators 32 in the LIDAR chip of FIG. 1A and/or FIG. 1B. The illustrated composite signal generator 32 includes a light signal combiner 140 configured to receive light signals from one of the reference waveguides 36 and one of the comparative waveguides 30. When the reference waveguide 36 receives a reference signal, the reference waveguide 40 carries the reference signal to the light signal combiner 140. When a channel waveguide 30 receives a comparative signal, the channel waveguide 30 carries the comparative signal to the light signal combiner 140. When the light signal combiner 140 receives a comparative signal and a reference signal, the light signal combiner 140 combines the comparative signal and the reference signal into a composite signal. Due to a difference in frequencies between the comparative signal and the reference signal, the composite signal is beating at a beat frequency.

The light signal combiner 140 also splits the composite signal onto a first detector waveguide 142 and a second detector waveguide 144. The first detector waveguide 142 carries a first portion of the composite signal to a first light sensor 146 that converts the first portion of the composite signal to a first electrical signal. The second detector waveguide 144 carries a second portion of the composite signal to a second light sensor 148 that converts the second portion of the composite signal to a second electrical signal. Examples of suitable light sensors include germanium photodiodes (PDs), and avalanche photodiodes (APDs).

In some instances, the light signal combiner 140 splits the composite signal such that the portion of the comparative signal included in the first portion of the composite signal is phase shifted by 180° relative to the portion of the comparative signal in the second portion of the composite signal but the portion of the reference signal in the first portion of the composite signal is not phase shifted relative to the portion of the reference signal in the second portion of the composite signal. Alternately, the light signal combiner 140 splits the composite signal such that the portion of the reference signal in the first portion of the composite signal is phase shifted by 180° relative to the portion of the reference signal in the second portion of the composite signal but the portion of the comparative signal in the first portion of the composite signal is not phase shifted relative to the portion of the comparative signal in the second portion of the composite signal.

As shown in FIG. 1A and FIG. 1B, the LIDAR chip can include multiple composite signal generator 32 constructed according to FIG. 3A. FIG. 3B illustrates an example of a portion of the electronics configured to process the output from the composite signal generator 32. The electronics 56 can connect the first light sensor 146 and the second light sensor 148 in each of the composite signal generators 32 as a balanced detector 149 that serves as a light detector that converts optical energy to electrical energy. As noted above, the different composite signal generators 32 are associated with different alternate channel indices. Accordingly, the light detectors in different composite signal generator 32 are each associated with a different one of the alternate channel indices. As an example, in FIG. 1B, one of the light detectors is labeled m=1 and one of the light detectors is labeled m=2.

Each of the light detectors is in electrical communication with a detector output line 154 that carries the output signal of the light detector. For instance, the serial connection in each of the balanced detectors is in communication with one of the detector output lines 154. The electronics 56 include a data processor 155 configured to generate LIDAR data that indicates a radial velocity and/or distance between the objects and the LIDAR system. The data processor 155 includes a switch 156. The detector output lines 154 are each in electrical communication with the switch 156. For instance, each of the detector output lines 154 can be connected to a different terminal of the switch 156. The switch 156 can be operated by the data processor 155 so as to select which of the light detector output signals is output from the switch 156 as a data signal. For instance, the data processor 155 can operate the switch 156 such that the light detector output signal associated with alternate channel index m=1 is output from the switch 156 or such that the light detector output signal associated with alternate channel index m=2 is output from the switch 156. Suitable switches 156 include, but are not limited to, electrical multiplexers.

The data processor 156 includes a beat frequency identifier 158 that receives the data signal and is configured to identify the beat frequency of the data signal. The beat frequency identifier 158 includes an Analog-to-Digital Converter (ADC) 168 that receives the data signal from the switch 156. The Analog-to-Digital Converter (ADC) 168 converts the data signal from an analog form to a digital form and outputs a digital data signal. The digital data signal is a digital representation of the data signal.

The beat frequency identifier 166 includes a mathematical transformer 170 configured to receive the digital data signal. The mathematical transformer 170 is configured to perform the mathematical operation on the received digital data signal. Examples of suitable mathematical operations include, but are not limited to, mathematical transforms such as Fourier transforms. In one example, the mathematical transformer 170 performs a Fourier transform on the digital signal so as to convert from the time domain to the frequency domain. The mathematical transform can be a real transform such as a real Fast Fourier Transform (FFT). A real Fast Fourier Transform (FFT) can provide an output that indicates magnitude as a function of frequency.

The mathematical transformer 170 can include a peak finder (not shown) configured to identify peaks in the output of the mathematical transformer 170. The peak finder can be configured to identify any frequency peaks associated with reflection of the system output signal by one or more objects located outside of the LIDAR system. For instance, frequency peaks associated with reflection of the system output signal by one or more objects located outside of the LIDAR system can fall within a frequency range. The peak finder can identify the frequency peak within the range of frequencies associated with the reflection of the system output signal by one or more objects located outside of the LIDAR system. The frequency of the identified frequency peak represents the beat frequency of the composite signal.

The electronics include a LIDAR data generator 172 that receives the output from the mathematical transformer 170. The LIDAR data generator 172 treats the frequency at the identified peak as the beat frequency of the comparative signal beating against all or a portion of a reference signal. The LIDAR data generator 172 can use the identified beat frequencies in combination with the frequency pattern of the LIDAR output signal and/or the system output signal to generate the LIDAR data. FIG. 3C illustrates an example of suitable frequency patterns for the outgoing LIDAR signals. The light source controller 62 can operate the light source 10 such that the outgoing LIDAR signals output from the light source 10 have a frequency versus time pattern according to FIG. 3C. There are two frequency versus time patterns shown in FIG. 3C. Each of the frequency versus time patterns is associated with one of the alternate channel indices. As a result, one of the frequency versus time patterns is labeled m=1 and one of the frequency versus time patterns is labeled m=2. The frequency versus time pattern labeled m=1 can represent the frequency versus time pattern for the outgoing LIDAR signal associated with the alternate channel index labeled m=1. The frequency versus time pattern labeled m=2 can represent the frequency versus time pattern for the outgoing LIDAR signal associated with the alternate channel index labeled m=2.

The frequency versus time patterns can be periodic as shown in FIG. 3C. For instance, FIG. 3C labels different cycles for the outgoing LIDAR signal associated with alternate channel index m=1. The different cycles are labeled cycleⱼ and cycleⱼ₊₁. The duration of each cycle corresponds to the duration of the period frequency versus time pattern. The frequency versus time patterns associated with alternate channel index m=2 can have cycles with the same duration as the frequency versus time patterns associated with alternate channel index m=1. For instance, FIG. 3C shows the cycles of the frequency versus time patterns associated with alternate channel index m=2 having the same duration as the cycles of the frequency versus time patterns associated with alternate channel index m=1; however, the frequency versus time pattern associated with alternate channel index m=2 is out of phase with the frequency versus time patterns associated with alternate channel index m=1. The out of phase nature of the frequency versus time pattern is evident from the maxima and minima in the frequency versus time pattern associated with alternate channel index m=2 occurring at different times from the maxima and minima in the frequency versus time pattern associated with alternate channel index m=1.

Each of the illustrated cycles for the different outgoing LIDAR signals includes K chirp periods where the chirp rate of the outgoing LIDAR signal is constant or substantially constant. The start time of each cycle coincides with the start of one of the chirp periods in the cycle. The chirp periods in the cycle of a frequency versus time pattern can be associated with a chirp period index k with a value from k=1 to K. In FIG. 3C, each chirp period is labeled CP_{k,m} where m represents the alternate channel index and k is a chirp period index. Accordingly, CP_{1,2} represents the first chirp period for the outgoing LIDAR signal associated with alternate channel index m=2. FIG. 3C shows each of the chirp periods having the same duration, however, chirp periods in the same cycle can have the same duration or different durations. In some instances, the duration of each chirp period in a cycle associated with a first one of alternate channel indices matches the duration of a chirp period the cycles associated with all or a portion of the other alternate channel indices. For instance, in FIG. 3C, the duration of chirp period CP_{1,1} can be equal to the duration of chirp period CP_{1,2} and the duration of chirp period CP_{2,1} can be equal to the duration of chirp period CP_{2,2}. In some instances, all or a portion of the chirp periods, in each cycle has a duration in a range from 0.1 μs, 1 μs, or 2 μs to 5 μs, 10 μs, or 100 μs.

The total change in the frequency that occurs during a chirp period can be considered a magnitude of the frequency change during the chirp period (chirp bandwidth). The magnitudes of the frequency change during the chirp periods in the same cycle can be the same or different. In FIG. 3C, the magnitudes of the frequency changes during each of the illustrated chirp periods is constant or substantially constant; however, a portion of the chirp periods have different directions for the total change in the frequency that occurs during a chirp period.

FIG. 3C illustrates each of the outgoing LIDAR signals having the same wavelength, however, the outgoing LIDAR signals can have different wavelengths. A difference in the wavelengths of the outgoing LIDAR signals shown in FIG. 3C can produce a shift upward or downward in one or both of the illustrated frequency versus time patterns.

The selector controller 72 operates the signal selector 16 so as to select the outgoing LIDAR signal that serves as the LIDAR output signal output from the LIDAR chip and accordingly as the source for the system output signal output from the LIDAR system. For instance, the selector controller 72 can be operated so as to define output windows such that a different one of the outgoing LIDAR signals is output from the signal selector 16 and/or the LIDAR during each of the output windows. The output windows can occur in series such that the different LIDAR output signals are serially output from the LIDAR chip and accordingly different system output signals are serially output from the LIDAR system.

The signal selector 16 can be operated such that outgoing LIDAR signals associated with different alternate channel indices alternately serves as the LIDAR output signal output from the LIDAR chip and accordingly different system output signals output from the LIDAR system. For instance, LIDAR output signal output from the LIDAR chip can alternate between different alternate channel indices. As an example, FIG. 3D illustrates the frequency versus time pattern of LIDAR output signals that can result from the signal selector 16 operating on outgoing LIDAR signals having the frequency versus time pattern of FIG. 3C. The signal selector 16 is operated so as to alternate between selecting the outgoing LIDAR signal associated with alternate channel index m=1 to serve as the LIDAR output signal and selecting the outgoing LIDAR signal associated with alternate channel index m=2 to serve as the LIDAR output signal. Accordingly, the LIDAR output signals alternate between being associated with alternate channel index m=1 and alternate channel index m=2.

The selector controller 72 is operated such that the duration of each LIDAR output signal being transmitted is less than the chirp period for the outgoing LIDAR signal that is the source of light in LIDAR output signal. For instance, FIG. 3D labels the time where each LIDAR output signal is output as LOS_{k,m} where m represents the alternate channel index and k is the chirp period index. Accordingly, the LIDAR output signal output during LOS_{1,2} is associated with the alternate channel index m=2 and includes light from an outgoing LIDAR signal associated with chirp period index k=1. As an example, the LIDAR output signal output during LOS_{1,2} includes or consists of light from the outgoing LIDAR signal generated during chirp period CP_{1,2}. In some instances, the duration of each LIDAR output signal is selected such that the duration of LOS_{k,m}=CP_{k,m}/K. As is evident from FIG. 3D, the frequency versus time patterns for each of the LIDAR output signals is a fraction of the frequency versus time pattern for one of the outgoing LIDAR signals. Accordingly, each of the LIDAR output signals represents a fraction of one of the outgoing LIDAR signals.

Although FIG. 3D is disclosed in the context of outgoing LIDAR signals, each of the system output signals includes light from one of the outgoing LIDAR signals selected by the signal selector. As a result, the frequency versus time pattern disclosed in FIG. 3D can also represent the frequency versus time pattern of the system output signals transmitted from the LIDAR system. Accordingly, the system output signals can be serially transmitted from the LIDAR system as shown in FIG. 3D. Additionally, the time where each LIDAR output signal is output can also represent the time where each system output signal is output. Accordingly, the LOS_{k,m} labels can represent the output windows for the system output signals.

FIG. 3E shows the frequency versus time patterns for a portion of the LIDAR output signals shown in FIG. 3D. The frequency versus time patterns for a portion of the LIDAR output signals have been removed from FIG. 3E in order to simplify the illustration. The frequency versus time pattern for the LIDAR output signal output during LOS_{1,1} is shown by a solid line under the label LOS_{1,1}. The frequency versus time pattern for the LIDAR output signal output during LOS_{2,2} is shown by a solid line under the label LOS_{1,1}.

The shortest distance that a reflecting object can be positioned from the LIDAR system with the LIDAR system providing reliable LIDAR data can be represented by “di.” When the object is positioned a distance “di” from the LIDAR system and is illuminated by a LIDAR output signal output during LOS_{k,m}, the window of time during which the resulting LIDAR input signal is received by the LIDAR system can be labeled rwdi_{k,m}. As an example, FIG. 3E has a time window labeled rwdi_{1,1} and the dashed line within this time window represents the frequency versus time pattern of a LIDAR input signal that results from the LIDAR output signal output during LOS_{1,1} being reflected by an object positioned at “di.” As another example, FIG. 3E has a time window labeled rwdi_{2,2} and the dashed line within this time window represents the frequency versus time pattern of a LIDAR input signal that results from the LIDAR output signal output during LOS_{2,2} being reflected by an object positioned at “di.” The distance between the signals represented by the solid line and the resulting signals represented by dashed lines is a result of the LIDAR output signal traveling from the LIDAR system to the object and then from the object to the LIDAR system. For instance, the distance between the signal represented by the solid line under the time window label LOS_{1,1} and the dashed line in the time window labeled rwdi_{1,1} in FIG. 3E is a result of the LIDAR output signal traveling from the LIDAR system to the object and then from the object to the LIDAR system.

The longest distance that a reflecting object can be positioned from the LIDAR system with the LIDAR system providing reliable LIDAR data can be represented by “da.” When the object is positioned a distance “da” from the LIDAR system and is illuminated by a LIDAR output signal output during LOS_{k,m}, the window of time during which the resulting LIDAR input signal is received the LIDAR system can be labeled rwda_{k,m}. As an example, FIG. 3E has a time window labeled rwda_{1,1} and the dashed line within this time window represents the frequency versus time pattern of a LIDAR input signal that results from the LIDAR output signal output during LOS_{1,1} being reflected by an object positioned at “da.” As another example, FIG. 3E has a time window labeled rwda_{2,2} and the dashed line within this window represents the frequency versus time pattern of a LIDAR input signal that results from the LIDAR output signal output during LOS_{2,2} being reflected by an object positioned at “da.” The distance between the signals represented by the solid line and the resulting signals represented by dashed lines is a result of the LIDAR output signal traveling from the LIDAR system to the object and the reflected light traveling from the from the object to the LIDAR system. For instance, the distance between the signal represented by the solid line under the time window label LOS_{1,1} and the dashed line in the time window labeled rwda_{1,1} in FIG. 3E is a result of the LIDAR output signal traveling from the LIDAR system to the object and then from the object to the LIDAR system. The frequency versus time pattern of the LIDAR input signals shown in FIG. 3E can also represent the frequency versus time pattern of the comparative signals that results from the LIDAR input signals.

Although FIG. 3E shows no overlap between the return window rwdi_{k,m} and the return window rwda_{k,m}, in some instances, the return window rwdi_{k,m} overlaps the return window rwda_{k,m}.

The data processor 155 operates the switch 156 so the data signal is available to the beat frequency identifier 158 for sufficient time for the beat frequency identifier 158 to accurately identify the beat frequency when the object is in the range from “di” to “da.” In order for the beat frequency of the composite signal to be identified, the data signal needs to have a contribution from a comparative signal because the beating of the comparative signal against the reference signal is the source of the beat frequency. FIG. 3E labels different measurement windows where the beat frequency of the data signal, and accordingly the beat frequency of the composite signal, can be identified as w_{k,m} where m represents the alternate channel index and k is the chirp period index associated with the LIDAR output signal and/or the outgoing LIDAR signal that are the source of the light in the comparative signal included in the composite signal. For instance, the measurement window labeled w_{2,1} can be used to determine the beat frequency of the comparative signal that includes or consists of light from the LIDAR output signal output during LOS_{2,1} and accordingly that includes or consists of light from the light from the outgoing LIDAR signal generated during chirp period CP_{2,1}.

The data processor 155 can operate the switch 156 so the measurement windows are positioned so the light detector output signal associated with alternate channel index m is output from the switch 156 during measurement windows labeled w_{k,m}. As an example, the switch 156 can be operated so the light detector output signal associated with alternate channel index m=1 is output from the switch 156 during measurement windows labeled w_{k,1} and such that the light detector output signal associated with alternate channel index m=2 is output from the switch 156 during measurement windows labeled w_{k,2}. As a result, beat frequency identifier 158 receives the data signal associated with alternate channel index m during measurement windows labeled w_{k,m}.

As evident from FIG. 3E, the measurement windows labeled w_{k,m} are positioned so each of the measurement windows overlaps both the return window rwdi_{k,m} and the return window rwda_{k,m}. For instance, FIG. 3E shows the measurement windows labeled w_{1,1} overlapping the return window rwdi_{1,1} and the return window rwda_{1,1}. As another example, the measurement windows labeled w_{2,2} overlaps the return window rwdi_{2,2} and the return window rwda_{2,2}. As a result, when the object is within the range extending from “di” to “da,” the LIDAR system receives a LIDAR input signal during the measurement window associated with the LIDAR input signal. For instance, when a reflecting object within the range extending from “di” to “da” is illuminated by a LIDAR output signal output during LOS_{k,m}, the LIDAR system receives at least a portion of the resulting LIDAR input signal during the measurement windows w_{k,m}. As an example, when a reflecting object within the range extending from “di” to “da” is illuminated by a LIDAR output signal output during LOS_{1,1}, the LIDAR system receives at least a portion of the resulting LIDAR input signal during the measurement windows w_{1,1}. Since the LIDAR input signal is the source of the comparative signal, the comparative signal and the resulting composite signal also become available during the associated measurement window. Since the composite signal is the source of the data signal, when the object is positioned in the operational range of the LIDAR system from “di” to “da,” the data signal received by the beat frequency identifier 158 during the measurement window w_{k,m} includes a contribution from the LIDAR input signal and accordingly from the comparative signal that results from that LIDAR input signal. As a result, the resulting signal is beating at the desired beat frequency and the beat frequency identifier 158 can identify the beat frequency of the composite signal.

The measurement windows shown in FIG. 3E are also shown in FIG. 3D. As is evident from FIG. 3D, each measurement window overlaps the output window of multiple different LIDAR output signals and accordingly the output window of multiple different system output signals. As is evident in the change in the value of m in the illustrated values for LOS_{k,m}, each measurement window overlaps the output LIDAR output signals and the system output signals associated with different alternate channel indices. In particular, each measurement window overlaps the output window of the system output signal that is associated with the same alternate channel index as the measurement window and also overlaps the output of the next system output signal that is output from the LIDAR system. As a result, while the LIDAR system is outputting one system output signal, the comparative signal that results from the prior system output signal is being generated and the beat frequency identifier 158 is receiving the data signal that results from the output of the prior system output signal.

Increasing the degree by which the measurement windows overlap the output of the next system output signal decreases the amount of time that the beat frequency identifier 158 receives the data signal when the object is closer to the LIDAR system. For instance, shifting the measurement windows to the right in FIG. 3E reduces the level of overlap between the measurement window w_{k,m} and the return window rwdi_{k,m}. This reduction in time can reduce the accuracy of the beat frequency calculations when the object is closer to the LIDAR system. However, an increase in the power of the comparative signals that occurs when the object is closer to the LIDAR system may at least partially balance this loss in accuracy by increasing the signal-to-noise ratio of the composite signal so as to enhance the accuracy of the beat frequency calculations.

The window labeled “overlap_{f}” in FIG. 3E provides an example of a measurement windows (w_{k,m}) overlapping the output of the LIDAR output signal associated with the same alternate channel index, m. For instance, the window labeled “overlap_{f}” in FIG. 3E illustrates a time window where the measurement window w_{1,1} overlaps the output of the LIDAR output signal LOS_{1,1}. The window labeled “overlapₛ” in FIG. 3E provides an example of a measurement windows w_{k,m} overlaps the output of the next LIDAR output signal. For instance, the window labeled “overlapₛ” in FIG. 3E illustrates a time window where the measurement window w_{1,1} overlaps the output of the next LIDAR output signal output after the time window labeled LOS_{1,1}. More specifically, the window labeled “overlapₛ” in FIG. 3E illustrates a time window where the measurement window w_{1,1} overlaps the output of the LIDAR output signal in time LOS_{1,2}. The time window LOS_{1,2} is not labeled in FIG. 3E in order to reduce the complexity of the image but can be seen in FIG. 3D. All or a portion of the measurement windows w_{k,m} can each overlap the output of the LIDAR output signal associated with the same alternate channel index by less than 95%, or 80% of the output of the LIDAR output signal associated with the same alternate channel index and/or overlap the output of the next LIDAR output signal by more than 1% or 20% of the duration of the output of the next LIDAR output signal. In some instances, all or a portion of the measurement windows w_{k,m} each overlaps the output of the LIDAR output signal associated with the same alternate channel index by less than 5%, 10%, or 20% of the output of the LIDAR output signal associated with the same alternate channel index and/or overlap the output of the next LIDAR output signal by more than 80%, 90%, or 95% of the duration of the output of the next LIDAR output signal. For instance, all or a portion of the measurement windows w_{k,m} each overlaps the output of the LIDAR output signal during LOS_{k,m} by less than 5%, 10%, or 20% of the duration of the output of the LIDAR output signal during LOS_{k,m} and/or overlap the output of the LIDAR output signal during LOS_{k,m′} by more than 80%, 90%, or 95% of the duration of the output of the LIDAR output signal during LOS_{k,m′} where m′=m+1 when m<M and m′=1 when m=M.

A comparison of FIG. 3C and FIG. 3D shows that the chirp periods of the outgoing LIDAR signals (CP_{m,k}) exceed the output windows of the LIDAR output signals and the system output signals that include light from those outgoing LIDAR signals. Different LIDAR output signals and different system output signals are associated with the same sample region in a field of view in that they are each used in the calculation of LIDAR data for the associated sample region. In some instances, each of the system output signals that are associated with the same sample region in the field of view carry light that is included in one of several system output signals that each illuminate that sample region and/or have spot sizes that overlap at “da”. System output signals that are associated with the same alternate channel index can travel away from the LIDAR system in the same direction or substantially the same direction. In FIG. 3D, system output signals that are associated with the same alternate channel index can be associated with the same sample region in the field of view. As an example, in FIG. 3D, the system output signals output during the same cycle and labeled LOS_{1,1} and LOS_{2,1} can be associated with the same sample region in the field of view. As is evident from FIG. 3D, the chirp directions of the system output signals output during the same cycle and labeled LOS_{1,1} and LOS_{2,1} have different chirp directions. System output signals associated with the same sample region can be output during output windows that are separated by one or more output windows for LIDAR output signals that are not associated with the sample region. As an example, FIG. 3D shows the output windows labeled LOS_{1,1}, LOS_{1,2} and LOS_{2,1} that occur during the same cycle with the output window labeled LOS_{1,2}, being positioned between the output windows labeled LOS_{1,1} and LOS_{2,1}. Accordingly, one or more system output signals that are not associated with a sample region can be output between system output signals that are associated with the sample region.

Since each system output signal includes light from one of the LIDAR output signals, the system output signals can be associated with the same sample region as the LIDAR output signals from which the system output signals are generated. In some instances, each of the system output signals associated with the same sample region illuminates at least a portion of the sample region and/or have spot sizes that overlap at “da”. As a result, system output signals that are associated with the same alternate channel index can travel away from the LIDAR chip in the same direction or substantially the same direction. System output signals that are associated with the same alternate channel index can be associated with the same sample region in the field of view. System output signals that are associated with the same alternate channel index can have different chirp rates and/or different chirp directions. System output signals associated with the same sample region can be output during output windows that are separated by the output windows of one or more system output signals that are not associated with the sample region. For instance, one or more system output signals that are not associated with a sample region can be output between system output signals that are associated with the sample region.

The beat frequencies that result from the system output signals associated with the same sample region and/or from the LIDAR output signals associated with the same sample region can be combined to generate the LIDAR data for the sample region. For instance, the beat frequency determined from the composite signals and/or comparative signals that include light from the LIDAR output signals output during the same cycle and labeled LOS_{1,1} and LOS_{2,1} in FIG. 3D can be combined to generate the LIDAR data for the sample region. A beat frequency determined from the composite signal and/or comparative signal that includes light from the LIDAR output signal output during LOS_{k,m} can be expressed as f_{k,m}. As an example, f_{1,1} can represent the beat frequency identified for a composite signal that includes light from the LIDAR output signals output during an output window labeled LOS_{1,1}. The following equation applies to a composite signal that includes light from a LIDAR output signal chirped so as to have an increasing frequency. For instance, the following equation applies to a composite signal that includes light from a LIDAR output signal output during the output window labeled LOS_{1,1} in FIG. 3D: f_{ub}=−f_{d}+ατ where f_{ub} is the beat frequency determined from the output of the mathematical transformer 170, f_{d} represents the Doppler shift (f_{d}=2νf_{c}/c) where f_{c} represents the optical frequency (fₒ), c represents the speed of light, ν is the radial velocity between the reflecting object and the LIDAR system where the direction from the reflecting object toward the LIDAR system is assumed to be the positive direction, and c is the speed of light. The following equation applies to a composite signal that includes light from a LIDAR output signal chirped so as to have a decreasing frequency. For instance, the following equation applies to a composite signal that includes light from a LIDAR output signal output during the output window labeled LOS_{2,1} in FIG. 3D: f_{db}=−f_{d}−ατ where f_{db} is the beat frequency determined from the output of the mathematical transformer 170. In these two equations, f_{d} and τ are unknowns. The two equations can be solved for the two unknowns and the beat frequency values determined from composite signals that include light from LIDAR output signals and/or system output signals associated with the same sample region substituted into the result to calculate values of f_{d} and τ for the sample region. The radial velocity for the sample region can be determined from the Doppler shift (ν=c*f_{d}/(2f_{c})) and/or the separation distance for the sample region can be determined from c*τ/2. Accordingly, the beat frequencies beat frequency of composite signals and that include light from the LIDAR output signals associated with the same sample region can serve variables in the equations that the electronics use to calculate LIDAR data for the sample region.

Since LIDAR data can be generated for each corresponding frequency pair output by the mathematical transformer 170, separate LIDAR data can be generated for each of the objects in a sample region. Accordingly, the electronics can determine more than one radial velocity and/or more than one radial separation distance from a single sampling of a single sample region in the field of view.

Suitable platforms for construction for a LIDAR chip include, but are not limited to, silicon-on-insulator wafers, silica wafers, and silicon nitride on silicon wafers. FIG. 4 illustrates a portion of a LIDAR chip that includes a waveguide with a construction that is suitable for use with chips constructed from silicon-on-insulator wafers. A ridge 306 of the light-transmitting medium 304 extends away from slab regions 308 of the light-transmitting medium 304. The light signals are constrained between the top of the ridge and the buried layer 300. As a result, the ridge 306 at least partially defines the waveguide.

The dimensions of the ridge waveguide are labeled in FIG. 4. For instance, the ridge has a width labeled w and a height labeled h. The thickness of the slab regions is labeled t. For LIDAR applications, these dimensions can be more important than other applications because of the need to use higher levels of optical power than are used in other applications. The ridge width (labeled w) is greater than 1 μm and less than 4 μm, the ridge height (labeled h) is greater than 1 μm and less than 4 μm, the slab region thickness is greater than 0.5 μm and less than 3 μm. These dimensions can apply to straight or substantially straight portions of the waveguide, curved portions of the waveguide and tapered portions of the waveguide(s). Accordingly, these portions of the waveguide will be single mode. However, in some instances, these dimensions apply to straight or substantially straight portions of a waveguide. Additionally, or alternately, curved portions of a waveguide can have a reduced slab thickness in order to reduce optical loss in the curved portions of the waveguide. For instance, a curved portion of a waveguide can have a ridge that extends away from a slab region with a thickness greater than or equal to 0.0 μm and less than 0.5 μm. While the above dimensions will generally provide the straight or substantially straight portions of a waveguide with a single-mode construction, they can result in the tapered section(s) and/or curved section(s) that are multimode. Coupling between the multi-mode geometry to the single mode geometry can be done using tapers that do not substantially excite the higher order modes. Accordingly, the waveguides can be constructed such that the signals carried in the waveguides are carried in a single mode even when carried in waveguide sections having multi-mode dimensions. The waveguide construction of FIG. 4 is suitable for all or a portion of the waveguides on the LIDAR chip.

An example of a suitable signal selector 16 includes amplifiers. FIG. 5A is schematic of an example of a suitable signal selector 16. The signal selector 16 includes amplifiers 314 that each receives an outgoing LIDAR signal from one of the utility waveguides 12. In FIG. 3A, the utility waveguides 12 serve as the selector waveguide shown in FIG. 1A and FIG. 1B. All or a portion of the amplifiers included in the signal selector 16 can be included in an amplifier chip. As an example, FIG. 5B is a schematic of a signal selector 16 that includes the amplifiers 314 on an amplifier chip 327. Each of the amplifiers is associated with one of the alternate channel indices. The amplifiers associated with alternate channel index m receives the outgoing LIDAR signal associated with alternate channel index m. Although FIG. 5B illustrates the signal selector 16 positioned along the length of the utility waveguides 12, the signal selector 16 can be positioned at the terminus of the utility waveguides 12 and/or at the edge of the LIDAR chip as illustrated in FIG. 1A and FIG. 1B.

The selector controller 72 can operate each of the amplifiers 314 so as to amplify the power of the outgoing LIDAR signals passing through the amplifier or to allow the preliminary outgoing LIDAR signal to pass through the amplifier without amplification. In some instances, operating an amplifier below an amplification threshold effectively causes attenuation of the preliminary outgoing LIDAR signal. As an example, Semiconductor Optical Amplifiers (SOAs) amplify a preliminary outgoing LIDAR signal when a forward bias is applied to the Semiconductor Optical Amplifier (SOA). When a reverse-bias is applied to the Semiconductor Optical Amplifiers (SOAs), a gain medium in the SOA absorbs at least a portion of the outgoing LIDAR signal and further attenuates the outgoing LIDAR signal. Accordingly, when the selector controller 72 operates one of the amplifiers 314 such that the electrical current through the gain medium falls below the current threshold, the amplifier 314 can attenuate the power of the outgoing LIDAR signal. As a result, the selector controller 72 can operate each of the amplifiers 314 such that the amplifier outputs an outgoing LIDAR signal that is amplified relative to the outgoing LIDAR signal received by the amplifier 314, that is unamplified relative to the outgoing LIDAR signal received by the amplifier 314, that is attenuated relative to the preliminary outgoing LIDAR signal received by the amplifier 314, or that has zero, insubstantial or negligible power. The LIDAR output signal output from the LIDAR chip can each include or consist of light from an outgoing LIDAR signal that is amplified relative to the outgoing LIDAR signal received by an amplifier 314. Any inactive LIDAR output signals output from the LIDAR chip can each include or consist of light from an outgoing LIDAR signal that is not amplified relative to the outgoing LIDAR signal received by an amplifier 314, that is not substantially amplified relative to the outgoing LIDAR signal received by an amplifier 314, or that has an attenuated power level relative to the power level of the outgoing LIDAR signal received by an amplifier 314.

The selector controller 72 can operate the amplifiers 314 so as to select which amplifiers 314 serve as an active amplifier and which amplifiers 314 serve as an inactive amplifier. For instance, the selector controller 72 can operate one or more amplifiers 314 so as to substantially amplify the power of the system output signals to the desired levels. Additionally, the selector controller 72 can concurrently operate one or more amplifiers 314 so to not amplify, or not substantially amplify, the power of the light included in the outgoing LIDAR signal received by each of the one or more amplifiers. Amplifiers that substantially amplify the power of the light included in the system output signal output from the amplifier serve as the active amplifiers. The amplifiers that do not amplify, or do not substantially amplify, the power of the light included in the outgoing LIDAR signal received by each of the one or more amplifiers serve as the inactive amplifiers. One example of a suitable amplifier includes Semiconductor Optical Amplifiers (SOAs). Semiconductor Optical Amplifiers (SOAs) include a semiconductor gain medium to which a forward electrical bias so as to amplify the power of the light in the outgoing LIDAR signal received by the SOA. These amplifiers can be operated as active amplifiers by applying an electrical bias above a threshold voltage in the direction needed to provide amplification. Semiconductor Optical Amplifiers (SOAs) can also be operated as inactive amplifiers by not applying an electrical bias to the amplifier, by applying the electrical bias below the threshold voltage in the direction needed to provide amplification, by applying a reverse electrical bias to the amplifier so as to attenuate the power of the light in the system output signal, or by applying the electrical bias in the direction opposite from the direction needed to provide amplification. Application of the electrical bias in the direction opposite from the direction needed to provide amplification can provide attenuation of the system output signal. For instance, a forward bias above a voltage threshold is often applied to Semiconductor Optical Amplifiers (SOAs) in order to achieve amplification while application of a reverse bias can provide attenuation. Accordingly, the inactive amplifiers can output a system output signal with a power level that is the same as, substantially the same as, or below the power of the preliminary outgoing LIDAR signal received by the amplifier.

The operation of the amplifiers 314 selects which of the outgoing LIDAR signals carries the light that is included in the LIDAR output signal output from the LIDAR chip and accordingly in the system output signal output from the LIDAR system. For instance, an outgoing LIDAR signal output from the active amplifier can be the source of the light included in the LIDAR output signal output from the LIDAR chip and accordingly in the system output signal output from the LIDAR system. In some instances, all or a portion of the amplifiers 314 can have a length such that when the selector controller 72 operates an amplifier as an inactive amplifier, an outgoing LIDAR signal is not output from the amplifier or an inactive outgoing LIDAR output signal is output from the amplifier with a power level that is insubstantial relative to the power level of the LIDAR output signal output from the LIDAR chip. In the event that one or more of the inactive amplifiers outputs an outgoing LIDAR signal with a power level that is negligible or insubstantial relative to the power of the active outgoing LIDAR signal, the signal output from the inactive amplifier can serve as an inactive outgoing LIDAR signal. Accordingly, inactive amplifiers can output an inactive outgoing LIDAR signal or no outgoing LIDAR signal at all. While the electronics use light from any active outgoing LIDAR signals to generate LIDAR data, the electronics do not use light from inactive outgoing LIDAR signal to generate LIDAR data.

In some instances, the selector controller 72 operates the amplifiers 314 such that a ratio of the power of the outgoing LIDAR signal output from an active amplifier: the power of any inactive outgoing LIDAR signal output from an inactive amplifier is greater than 10,000:1, 1000:1 or 100:1 for each of the inactive amplifiers and can be infinitely high when an inactive amplifier 314 outputs an outgoing LIDAR signal with a zero power level or does not output an outgoing LIDAR signal. Additionally, or alternately, in some instances, the selector controller 72 can operate all or a portion of the active amplifiers 314 such that a power level of the outgoing LIDAR signal output from the active amplifier is more than 10, 50, or 100 times the power level of the outgoing LIDAR signal received by the active amplifier. Additionally, or alternately, in some instances, the selector controller 72 can operate all or a portion of the inactive amplifiers 314 such that a power level of the outgoing LIDAR signal received by the inactive amplifier is more than 10, 100, or 1000 times a power level of the inactive outgoing LIDAR signal output from the inactive amplifier.

The selector controller 72 operates the amplifiers 314 so as to alternate the active amplifier between amplifiers associated with different alternate channel indices. For instance, the amplifiers frequency versus time patterns for the LIDAR output signals shown in FIG. 3D can be generated by operating the amplifiers such that the amplifier associated with alternate channel index m=1 can be alternated with the amplifier associated with alternate channel index m=2. The amplifier associated with alternate channel index m=1 can be turned off for all or a portion of the time that amplifier associated with alternate channel index m=2 amplifies the outgoing LIDAR signal associated with alternate channel index m=2 and the amplifier associated with alternate channel index m=2 can be turned off for all or a portion of the time that amplifier associated with alternate channel index m=1 amplifies the outgoing LIDAR signal associated with alternate channel index m=1. This allows the active amplifier to amplify the active system output signal to the desired power level while energy is conserved by turning off any inactive amplifiers.

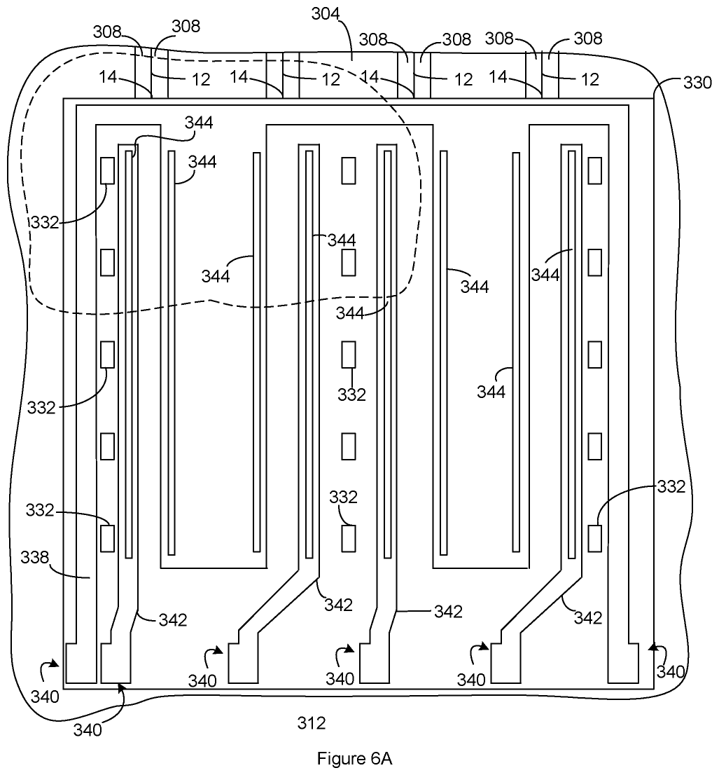

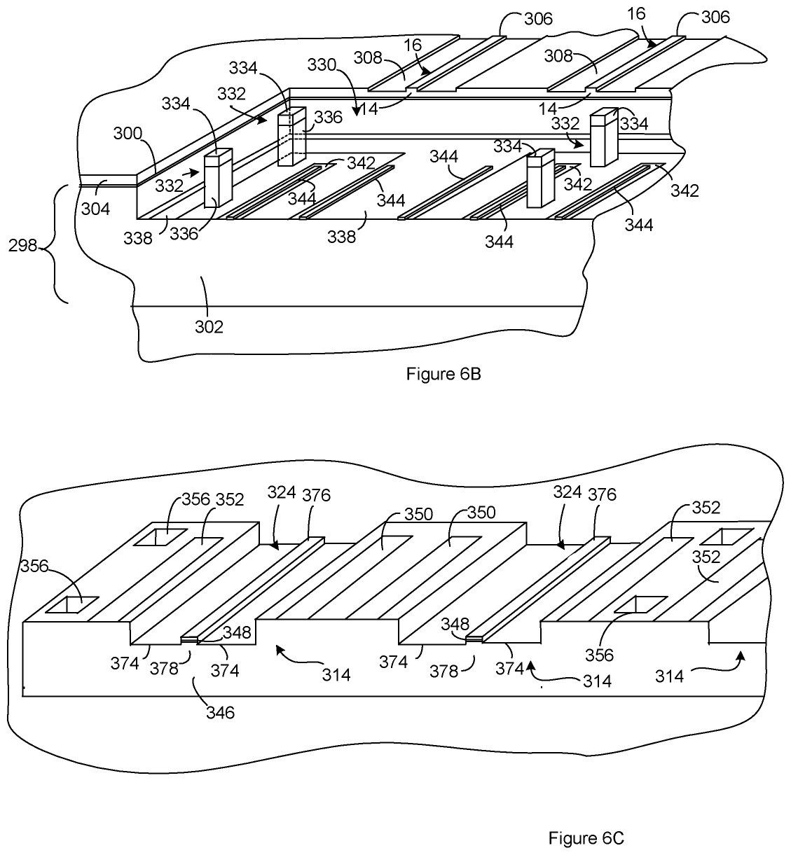

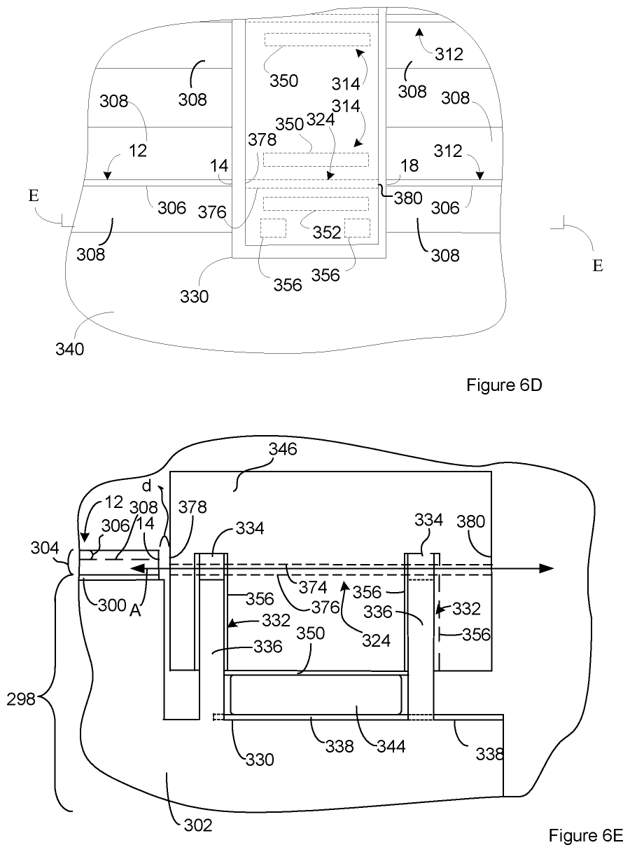

FIG. 6A through FIG. 6E illustrate an example of an interface between an amplifier chip and a LIDAR chip. FIG. 6A is a topview of a portion of a LIDAR chip that includes an interface for optically coupling the LIDAR chip with an amplifier chip. FIG. 6B is a perspective view of the portion of a LIDAR chip shown by the dashed lines in FIG. 6A labeled B. The LIDAR chip includes a stop recess 330 sized to receive the amplifier chip. The stop recess 330 extends through the light-transmitting medium 304 and into the base 298. In the illustrated version, the stop recess 330 extends through the light-transmitting medium 304, the buried layer 300, and into the substrate 302.

The facets 14 of the utility waveguides 12 are included in the lateral sides of the stop recess 330. Although not shown, the facets 14 of the utility waveguides 12 can include an anti-reflective coating. A suitable anti-reflective coating includes, but is not limited to, single-layer coatings such as silicon nitride or aluminum oxide, or multi-layer coatings, which may contain silicon nitride, aluminum oxide, and/or silica.

One or more stops 332 extend upward from the bottom of the stop recess 330. For instance, FIG. 6B illustrates four stops 332 extending upward from the bottom of the stop recess 330. The stops 332 include a cladding 334 positioned on a base portion 336. The substrate 302 can serve as the base portion 336 of the stops 332 and the stop 332 can exclude the buried layer 300. The portion of the substrate 302 included in the stops 332 can extend from the bottom of the stop recess 330 up to the level of the buried layer 300. For instance, the stops 332 can be formed by etching through the buried layer 300 and using the underlying substrate 302 as an etch-stop. As a result, the location of the top of the base portion 336 relative to the optical mode of a light signal in a utility waveguide 12 is well known because the buried layer 300 defines the bottom of the second waveguide and the top of the base portion 336 is located immediately below the buried layer 300. The cladding 334 can be formed on base portion 336 of the stops 332 so as to provide the stops 332 with a height that will provide the desired vertical alignment between each amplifier waveguide on an amplifier chip and one of the utility waveguides 12.

A first electrical conductor 338 extends across a bottom of the stop recess 330. The first electrical conductor 338 can include a contact pad 340 that can be used to provide electrical communication between the electronics and the first electrical conductor 338. Second electrical conductors 342 each extend from across the bottom of the stop recess 330. Each of the second electrical conductors 342 can include a contact pad 340 that can be used to provide electrical communication between the electronics and the second electrical conductor 342. Solder 344 is positioned on the first electrical conductor 338 and the second electrical conductors 342.

FIG. 6C is a perspective view of one embodiment of an amplifier chip. The illustrated amplifier chip is within the class of devices known as planar optical devices. The amplifier chip includes an amplifier waveguide 324 defined in a gain medium 346. Suitable gain media include, but are not limited to, InP, InGaAsP, and GaAs.

Trenches 374 extending into the gain medium 346 define a ridge 376 in the gain medium 346. The ridge 376 defines an amplifier waveguide 324 that can serve as a selector waveguide 20 disclosed in the context of at least FIG. 1A and FIG. 1B. In some instances, the gain medium 346 includes one or more layers 348 in the ridge and/or extending across the ridge 376. The one or more layers 348 can be positioned between different regions of the gain medium 346. The region of the gain medium 346 above the one or more layers 348 can be the same as or different from the region of the gain medium 346 below the one or more layers 348. The layers can be selected to constrain light signals guided through the amplifier waveguide 324 to a particular location relative to the ridge 376. Each of the layers 348 can have a different composition of a material that includes or consists of two or more components selected from a group consisting of In, P, Ga, and As. In one example, the gain medium 346 is InP and the one or more layers 348 each includes Ga and As in different ratios.

The amplifier waveguide 324 provides an optical pathway between a first facet 378 and a second facet 380 that can serve as the port 18. Although not shown, the first facet 378 and/or the second facet 380 can optionally include an anti-reflective coating. A suitable anti-reflective coating includes, but is not limited to, single-layer coatings such as silicon nitride or aluminum oxide, or multi-layer coatings that may contain silicon nitride, aluminum oxide, and/or silica.

The amplifier chip includes first amplifier electrical conductors 350 and second amplifier electrical conductors 352. The first amplifier electrical conductors 350 are arranged on the amplifier chip such that the amplifier chip can be inverted and placed in the stop recess 330 with each of the first amplifier electrical conductors 350 aligned with a portion of the first electrical conductor 338 such that solder 344 is positioned between the first amplifier electrical conductors 350 and the first electrical conductor 338 with the solder contacting the first amplifier electrical conductors 350 and the first electrical conductor 338. The second amplifier electrical conductors 352 are arranged on the amplifier chip such that the amplifier chip can be inverted and placed in the stop recess 330 with each of the second amplifier electrical conductors 352 aligned with one of the second electrical conductors 340 such that solder 344 is positioned between the second amplifier electrical conductors 352 and the second electrical conductor 340 and the solder 344 contacts the second amplifier electrical conductors 352 and the second electrical conductor 340.

The amplifier chip also includes one or more alignment recesses 356. Each of the alignment recesses 356 is sized to receive one of the stops 332.

FIG. 6D and FIG. 6E illustrate a LIDAR system that includes the LIDAR chip of FIG. 6A and FIG. 6B interfaced with the amplifier chip of FIG. 6C. The LIDAR chip is inverted and positioned in the stop recess 330. FIG. 6D is a topview of the LIDAR system. FIG. 6E is a sideview of a cross section of the system taken through a utility waveguide 12 on the LIDAR chip and the amplifier waveguide 324 on the amplifier chip. For instance, the cross section of FIG. 6E can be taken a long a line extending through the brackets labeled E in FIG. 6D. FIG. 6D and FIG. 6E each includes dashed lines that illustrate features that are located behind other features in the system. For instance, FIG. 6D includes dashed lines the show the locations of the ridge 376 of the amplifier waveguide 324, the first amplifier electrical conductors 350, the second amplifier electrical conductors 352 and the alignment recesses 356 under the gain medium 346. Additionally, FIG. 6E includes dashed lines that illustrate the locations of the amplifier waveguide 324 behind the stops 332. FIG. 6E also includes dashed lines that illustrate the location where the ridge 86 of the utility waveguide 12 interfaces with the slab regions 308 that define the utility waveguide 12 and dashed lines that illustrate the location where the ridge 376 of the amplifier waveguide 324 interfaces with slab regions 374 of the amplifier chip.

The amplifier chip is positioned in the stop recess 330 on the LIDAR chip. The amplifier chip is positioned such that the ridge 376 of the amplifier waveguide 324 is located between the bottom of the amplifier chip and the base 298 of the LIDAR chip. Accordingly, the amplifier chip is inverted in the stop recess 330. Solder 344 or other electrically conducting adhesive contacts each of the first amplifier electrical conductors 350 and the first electrical conductor 338. Although not shown in FIG. 3E, the solder 344 or other electrically conducting adhesive contacts are arranged such that the solder 344 or other electrically conducting adhesive contacts each of the second amplifier electrical conductors 352 and one of the second electrical conductor 340. The solder 344 or other adhesive 358 can immobilize the amplifier chip relative to the LIDAR chip.

The facet 14 of the utility waveguide 12 is aligned with the first facet 378 of the amplifier waveguide 324 such that the utility waveguide 12 and the amplifier waveguide 324 can exchange light signals. As shown by the line labeled A, the system provides a horizontal optical path in that the direction that light signals travel from the utility waveguide 12 and through the amplifier chip before exiting the LIDAR chip through the second facet 380. A top of the first facet 378 of the amplifier waveguide 324 is at a level that is below the top of the facet 14 of the utility waveguide 12.

The one or more stops 332 on the LIDAR chip are each received within one of the alignment recesses 356 on the amplifier chip. The top of each stop 332 contacts the bottom of the alignment recess 356. As a result, the interaction between stops 332 and the bottom of the alignment recesses 356 prevents additional movement of the amplifier chip toward the LIDAR chip. In some instances, the amplifier chip rests on top of the stops 332.

As is evident from FIG. 6E, the first facet 378 of the amplifier waveguide 324 is vertically aligned with the facet 14 of the utility waveguide 12. As is evident from FIG. 6D, the first facet 378 of the amplifier waveguide 324 can also be horizontally aligned with the facet 14 of the utility waveguide 12. The horizontal alignment can be achieved by alignment of marks and/or features on the amplifier chip and the LIDAR chip.

The vertical alignment can be achieved by controlling the height of the stops 332 on the LIDAR chip. For instance, the cladding 334 on the base portion 336 of the stops 332 can be grown to the height that places the first facet 378 of the amplifier waveguide 324 at a particular height relative to the facet 14 of the utility waveguide 12. The desired cladding 334 thickness can be accurately achieved by using deposition techniques such as evaporation, plasma enhanced chemical vapor deposition (PECVD), and/or sputtering to deposit the one or more cladding layers. As a result, one or more cladding layers can be deposited on the base portion 336 of the stops 332 so as to form the stops 332 to a height that provides the desired vertical alignment. Suitable materials for layers of the cladding 334 include, but are not limited to, silica, silicon nitride, and polymers.

In FIG. 6E, the first facet 378 is spaced apart from the facet 14 by a distance labeled d. The distance “d” can be less than 5 μm, 3 μm, or 1 μm and/or greater than 0.0 μm. In FIG. 6E, the atmosphere in which the LIDAR chip is positioned is located in the gap between the first facet 378 and facet 14; however, other gap materials can be positioned in these gaps. For instance, a solid gap material can be positioned in the gap. Examples of suitable gap materials include, but are not limited to, epoxies and polymers.

FIG. 6E shows the solder 344 in contact with the first amplifier electrical conductor 350 and the first electrical conductor 338. As a result, the first amplifier electrical conductor 350, the solder 344, and the first electrical conductor 338 can provide electrical communication between a contact pad 340 on the first electrical conductor 338 and the amplifier. Although not illustrated, the second amplifier electrical conductor 352, the solder 344, and the second electrical conductor 342 can provide electrical communication between the contact pad 340 on the second electrical conductor 342 and an amplifier on the amplifier chip. Accordingly, the electronics can independently operate each of the amplifiers on the amplifier chip by applying a bias between contact pad 340 on the first electrical conductor 338 and the contact pad 340 on the second electrical conductor 342 that is associated with the amplifier. The bias can be applied so as to drive an electrical current through the gain medium in the amplifier. During concurrent operation of multiple different amplifiers, the first electrical conductor 338 can act as a common conductor.

As is evident from FIG. 1A, the LIDAR system can optionally include one or more light signal amplifiers 446 in addition to the amplifiers 314. For instance, an amplifier 446 can optionally be positioned along a utility waveguide 12 as illustrated in the light source 10 of FIG. 2. The electronics can operate the amplifier 446 so as to amplify the power of the outgoing LIDAR signal and accordingly of the resulting system output signal. As another example, an amplifier 446 can optionally be positioned along the detector output lines 154 as illustrated in FIG. 3B. Suitable amplifiers 446 for use on the LIDAR chip, include, but are not limited to, Semiconductor Optical Amplifiers (SOAs) and SOA arrays.

Light sensors that are interfaced with waveguides on a LIDAR chip can be a component that is separate from the chip and then attached to the chip. For instance, the light sensor can be a photodiode, or an avalanche photodiode. Examples of suitable light sensors include, but are not limited to, InGaAs PIN photodiodes manufactured by Hamamatsu located in Hamamatsu City, Japan, or an InGaAs APD (Avalanche Photo Diode) manufactured by Hamamatsu located in Hamamatsu City, Japan. These light sensors can be centrally located on the LIDAR chip. Alternately, all or a portion the waveguides that terminate at a light sensor can terminate at a facet located at an edge of the chip and the light sensor can be attached to the edge of the chip over the facet such that the light sensor receives light that passes through the facet. The use of light sensors that are a separate component from the chip is suitable for all or a portion of the light sensors selected from the group consisting of the first light sensor and the second light sensor.

As an alternative to a light sensor that is a separate component, all or a portion of the light sensors can be integrated with the chip. For instance, examples of light sensors that are interfaced with ridge waveguides on a chip constructed from a silicon-on-insulator wafer can be found in Optics Express Vol. 15, No. 21, 13965-13971 (2007); U.S. Pat. No. 8,093,080, issued on Jan. 10, 2012; U.S. Pat. No. 8,242,432, issued Aug. 14, 2012; and U.S. Pat. No. 6,108,8472, issued on Aug. 22, 2000 each of which is incorporated herein in its entirety. The use of light sensors that are integrated with the chip are suitable for all or a portion of the light sensors selected from the group consisting of the first light sensor and the second light sensor.

Suitable electronics 32 can include, but are not limited to, a controller that includes or consists of analog electrical circuits, digital electrical circuits, processors, microprocessors, digital signal processors (DSPs), Field Programmable Gate Arrays (FPGAs), computers, microcomputers, or combinations suitable for performing the operation, monitoring and control functions described above. In some instances, the controller has access to a memory that includes instructions to be executed by the controller during performance of the operation, control and monitoring functions. In some instances, the functions of the LIDAR data generator and the peak finder can be executed by Field Programmable Gate Arrays (FPGAs), digital signal processors (DSPs), Application Specific Integrated Circuits, firmware, software, hardware, and combinations thereof. Although the electronics are illustrated as a single component in a single location, the electronics can include multiple different components that are independent of one another and/or placed in different locations. Additionally, as noted above, all or a portion of the disclosed electronics can be included on the chip including electronics that are integrated with the chip.

An example of a suitable selector controller 72 executes the attributed functions using firmware, hardware, or software or a combination thereof. An example of a suitable light source controller 62 executes the attributed functions using firmware, hardware, or software or a combination thereof. An example of a suitable data processor 155 executes the attributed functions using firmware, hardware, or software or a combination thereof. An example of a suitable steering controller 60 executes the attributed functions using firmware, hardware, or software or a combination thereof.

Components on the LIDAR chip can be fully or partially integrated with the LIDAR chip. For instance, the integrated optical components can include or consist of a portion of the wafer from which the LIDAR chip is fabricated. A wafer that can serve as a platform for a LIDAR chip can include multiple layers of material. At least a portion of the different layers can be different materials. As an example, in a silicon-on-insulator wafer that includes the buried layer 300 between the substrate 302 and the light-transmitting medium 304 as shown in FIG. 4, the integrated on-chip components can be formed by using etching and masking techniques to define the features of the component in the light-transmitting medium 304. For instance, the slab regions 308 that define the waveguides and the stop recess can be formed in the desired regions of the wafer using different etches of the wafer. As a result, the LIDAR chip includes a portion of the wafer and the integrated on-chip components can each include or consist of a portion of the wafer. Further, the integrated on-chip components can be configured such that light signals traveling through the component travel through one or more of the layers that were originally included in the wafer. For instance, the waveguide of FIG. 4 guides light signal through the light-transmitting medium 304 from the wafer. The integrated components can optionally include materials in addition to the materials that were present on the wafer. For instance, the integrated components can include reflective materials and/or a cladding.

Numeric labels such as first, second, third, etc. are used to distinguish different features and components and do not indicate sequence or existence of lower numbered features. For instance, a second component can exist without the presence of a first component and/or a third step can be performed before a first step. The light signals disclosed above each include, consist of, or consist essentially of light from the prior light signal(s) from which the light signal is derived. For instance, an incoming LIDAR signal includes, consists of, or consists essentially of light from the LIDAR input signal.

Although the LIDAR system is disclosed as real signals such as the complex data signal, the LIDAR system can also use complex signals. As a result, the mathematical transform can be a complex transform and the component associated with the generation and use of a complex data signal having an in-phase component and a quadrature component can be added to the LIDAR system. As a result, the LIDAR system can use a multiple signal combiners and multiple ADCs. Additionally, or alternately, a single light sensor can replace each of the balanced detectors.

Other embodiments, combinations and modifications of this invention will occur readily to those of ordinary skill in the art in view of these teachings. Therefore, this invention is to be limited only by the following claims, which include all such embodiments and modifications when viewed in conjunction with the above specification and accompanying drawings.

1. A system, comprising:
a LIDAR system configured to output system output signals,
each of the system output signals being output during a different output window, and
the LIDAR system being configured to receive system return signals,
each of the system return signals including light from one of the system output signals that was reflected by an object located outside of the LIDAR system;
light combiners, each of the light combiners configured to combine light from the system return signals with light from reference signals so as to generate composite light signals, each of the composite light signals beating at a beat frequency;
an Analog-to-Digital Converter configured to receive data signals that are each beating at the beat frequency of one of the composite signals,
the Analog-to-Digital Converter receiving each of the data signals within a different measurement window, each of the measurement windows overlapping multiple of the output windows.

2. The system of claim 1, wherein each of the system output signals has a different chirp rate and/or a different chirp direction.

3. The system of claim 2, wherein the LIDAR system is configured to output different system output signals in series.

4. The system of claim 1, wherein the data signal that the measurement window are arranged in series.

5. The system of claim 1, wherein each of the data signals is beating at the beat frequency of one of the composite signals and the data signal received during each of the measurement windows is beating at the beat frequency of one of the composite signals that carries light from the system output signal that is output during one of the multiple output windows overlapped by the measurement window.

6. The system of claim 1, wherein each of the data signals is generated from a different one of the system output signals and the measurement window within which each data signals is received overlaps the output window of the system output signal from which the data signal is generated by less than 50% of a duration of the output window of the system output signal.

7. The system of claim 1, wherein each of the data signals is generated from a different one of the system output signals and the measurement window within which each data signals is received overlaps the output window of the system output signal from which the data signal is generated by less than 20% of a duration of the output window of the system output signal.

8. The system of claim 1, wherein the LIDAR system includes a switch that receives the data signals and selects which of the data signals is received by the Analog-to-Digital Converter.

9. The system of claim 8, wherein the Analog-to-Digital Converter receives the data signals from the switch.

10. A system, comprising:
a LIDAR system configured to generate outgoing LIDAR signals;
the LIDAR system having waveguides that receive the outgoing LIDAR signals such that different outgoing LIDAR signals are guided by different waveguides,
each of the outgoing LIDAR signal having a frequency versus time pattern that periodically repeats in cycles,
each cycle including multiple chirp periods,
a chirp rate of each outgoing LIDAR signal being constant in each of the chirp periods of the cycle associated with the outgoing LIDAR signal,
each of the outgoing LIDAR signals having different chirp rates and/or different chirp directions in different chirp periods of the cycle of the outgoing LIDAR signal;
the LIDAR system configured to output multiple system output signals,
each of the system output signals including light from one of the outgoing LIDAR signals and different system output signals including light from different outgoing LIDAR signals, and
a duration for the output of each system output signal being less than or equal to one half of a duration of one or more of the chirp periods in the cycle of the outgoing LIDAR signal that is a source of the light included in the system output signal.

11. The system of claim 10, wherein a duration of the cycle in the frequency versus time pattern for a first one of the outgoing LIDAR signals is the same as a duration of the cycle in the frequency versus time pattern for a second one of the outgoing LIDAR signals but maxima and minima in the frequency versus time pattern for the second outgoing LIDAR signal occur at different times from the maxima and minima in the frequency versus time pattern for the first outgoing LIDAR signal.

12. The system of claim 11, wherein the frequency versus time pattern for the second outgoing LIDAR signal has a frequency offset relative to the frequency versus time pattern for the first outgoing LIDAR signal.

13. The system of claim 10, wherein the LIDAR system includes a signal selector configured concurrently receive the outgoing LIDAR signals from the waveguides, the signal selector being configured to select which of the outgoing LIDAR signals received by the signal selector is output from the LIDAR system as the system output signal.

14. The system of claim 13, wherein the signal selector includes multiple amplifiers and each of the amplifiers receives a different one of the outgoing LIDAR signals.

15. A system, comprising:
a LIDAR system configured to output system output signals that each illuminates one of multiple sample regions in a field of view for the LIDAR system,
the system output signals including first system output signals that illuminate a first one of the sample regions and second system output signals that illuminate a second one of the sample regions;
the LIDAR system configured to receive system return signals that each includes light from one of the system output signals that was reflected by an object located outside of the LIDAR system,
the LIDAR system including light combiners that are each configured to combine light from the system return signals with light from reference signals so as to generate composite light signals,
the LIDAR system including a beat signal identifier having an Analog-to-Digital Converter configured to receive data signals that area each beating at the beat frequency of a different one of the composite signals,
the Analog-to-Digital Converter receiving a second one of the data signals between a first one of the data signals and a third one of the data signals,
the first data signal beating at the beat frequency of one of the composite signals that includes light from one of the first system output signals,
the second data signal beating at the beat frequency of one of the composite signals that includes light from one of the second system output signals,
the third data signal beating at the beat frequency of one of the composite signals that includes light from one of the first system output signals; and
the LIDAR system including a processor configured to calculate a LIDAR data result for each of the sample regions from the beat frequencies, the LIDAR data result for each sample region indicating a radial velocity and/or a distance between the LIDAR system and an object positioned in the sample region.

16. The system of claim 15, wherein the LIDAR system is configured to generate outgoing LIDAR signals,
the LIDAR system has waveguides that concurrently guide the outgoing LIDAR signals such that different outgoing LIDAR signals are guided by different waveguides, and
the first system output signals include light from a first one of the outgoing LIDAR signals and the second system output signals include light from a second one of the outgoing LIDAR signals.

17. The system of claim 15, wherein the LIDAR system includes a signal selector configured to concurrently receive the outgoing LIDAR signals from the waveguides, the signal selector being configured to select which one of the outgoing LIDAR signals received by the signal selector is output from the LIDAR system so as to serve as the system output signal.

18. The system of claim 17, wherein the signal selector includes multiple amplifiers and each of the amplifiers receives a different one of the outgoing LIDAR signals.
